(19) United States
(12) Patent Application Publication
(10) Pub. No.: US 2018/0031513 A1
(43) Pub. Date: Feb. 1, 2018

(54) CELL CHIP-BASED QUANTITATIVE ANALYSIS OF UNDIFFERENTIATED HUMAN PLURIPOTENT STEM CELL

(71) Applicant: SOGANG UNIVERSITY RESEARCH FOUNDATION, Seoul (KR)

(72) Inventors: Hyuk Jin CHA, Seoul (KR); Jeong Woo CHOI, Seoul (KR); Cheol Heon YEA, Seoul (KR); Ho Chang JEONG, Chungcheongnam-do (KR)

(73) Assignee: SOGANG UNIVERSITY RESEARCH FOUNDATION, Seoul (KR)

(21) Appl. No.: 15/550,106

(22) PCT Filed: Jul. 21, 2015
(86) PCT No.: PCT/KR2015/007541

§ 371 Date: Aug. 10, 2017

(30) Foreign Application Priority Data
Feb. 11, 2015 (KR) 10-2015-0020911

(51) Int. Cl. G01N 27/327; G01N 27/48

(52) U.S. Cl. CPC G01N 27/3277; G01N 27/48

(57) ABSTRACT

The present invention relates to a method for detecting an undifferentiated pluripotent stem cell, and a cell-chip using the same. Since the cell chip-based quantitative analysis method of the present invention does not use antibodies, unlike flow cytometry or real-time PCR which has been conventionally used for the quantitative analysis of pluripotent stem cells, there is an advantage in that it is possible to conveniently and rapidly perform quantitative analysis, and since the function of cells is not affected even after analysis, it is possible to recover and use the cells used in the analysis.

### TECHNICAL FIELD

This application claims priority to and the benefit of Korean Patent Application No. 10-2015-0020911, filed in the Korean Intellectual Property Office on 11 Feb. 2015, the disclosure of which is incorporated herein by reference.

The present invention relates to a method for cell chip-based quantitative analysis of undifferentiated human pluripotent stem cells.

### BACKGROUND ART

Human pluripotent stem cells (hPSCs), such as human embryonic stem cells (hESCs), induced pluripotent stem cells (iPSCs), and stem cell nuclear transfer (SCNT)-derived embryonic stem cells (ntESCs), have been considered promising resources for stem cell therapeutic agents due to their potency to differentiate into all cell types in the body (1, 2). Because of success in establishment of transgene-free iPSCs and ntESCs, immune rejection, which is one of the most serious obstacles to clinical application of PSC-based cell therapy, could be avoided, thereby autologous transplantation of stem cells (3). However, the risk of teratoma formation from residual undifferentiated PSCs during cell therapy has not been fully resolved. Despite the risk of teratoma (4-7), current in vivo animal studies on the formation of teratoma derived from human ESCs are very limited, unlike in vivo animal studies on the formation of teratoma derived from murine ESCs (mESCs) (8-12). The difference in teratoma formation between mESCs and hESCs appears as a bias for host-dependent tumorigenesis (13). Therefore, the formation of teratoma due to the presence of undifferentiated hESCs in recent primate models is a practical example to imply the risk of teratoma formation in the procedure of hPSC-based cell therapy (14).

A wide range of approaches has been tested to reduce the risk of teratoma formation from undifferentiated hPSCs, such as selecting differentiated cells or removing undifferentiated PSCs using cytotoxic antibodies (16, 17), compounds (18, 19), or suicide gene systems (20, 21). After ablation of undifferentiated hPSCs, their successful elimination should be confirmed in vitro by fluorescence-activated cell sorting (FACS), real-time PCR analysis, or immunostaining (22-24). However, FACS and immunostaining to confirm hPSCs contamination requiring labeling, and therefore, quantifying is difficult due to technical limitations in antibody gating (35). Similarly, a plurality of cells or whole cell populations may be necessarily destroyed even in real-time PCR analysis (26). Therefore, currently available techniques allow neither the recycle of important differentiated cells after safety assessment nor multi-stage monitoring. Considering the strict clinical standard for stem cell therapy and the laborious protocols required for the desired level of differentiated cells from hPSCs, non-destructive and label-free tools should be developed to determine hPSC contamination in mixed populations of differentiated stem cells. Recently, a chemical dye compound (Kyoto probe 1) for specifically labeling hPSCs (14) and a sandwich analysis system (“GlycoStem” test) for the detection of soluble hyperglycosylated podocalyxin proportional to the number of undifferentiated hPSCs have been developed (26).

Electrochemical cell-based biosensor, which is a non-destructive and label-free technique for monitoring various cell types, has been actively developed over the past decade (43, 44). Each type of cells, due to unique cell surface factors, has a cell-specific cyclic voltammetry (CV) profile based on varying current and resistance values (45).

Through the application of the CV profile, the present inventors have found a specific cathodic peak potential (E_{pc}) of undifferentiated hPSCs, which were detected by the simple cell chip-based cyclic voltammetry technique. In addition, the present invention proposes a continuous monitoring method capable of securing the safety of cell therapy-based hPSCs and performing quantitative analysis of undifferentiated pluripotent stem cells.

Throughout the entire specification, many papers and patent documents are referenced, and their citations are represented. The disclosures of cited papers and patent documents are entirely incorporated by reference into the present specification, and the level of the technical field within which the present invention falls, as well as details of the present invention are explained more clearly.

### DETAILED DESCRIPTION

### Technical Problem

The present inventors endeavored to develop a method for assessing the risk of teratoma formation from pluripotent stem cells used as stem cell therapeutic agents. As a result, the present inventors found that there is a specific cathodic peak potential (E_{pc}=−0.077 V) generated in undifferentiated pluripotent stem cells, and developed a method for detecting undifferentiated stem cells in mixed populations of differentiated cells and undifferentiated stem cells using the specific cathodic peak potential and further quantitatively analyzing undifferentiated stem cells. A method for detection of undifferentiated stem cells using electrochemical characteristics of the present invention, unlike FACS or real-time PCR requiring multiple steps for the entire process, is conveniently performed in a relatively short time and does not damage stem cells, thereby obtaining detection results with high reproducibility.

Therefore, an aspect of the present invention is to provide a method for detection of undifferentiated pluripotent stem cells.

Another aspect of the present invention is to provide a method for quantitative analysis of undifferentiated pluripotent stem cells.

Still another aspect of the present invention is to provide a cell chip for detection of undifferentiated pluripotent stem cells.

Other purposes and advantages of the present invention will become more obvious with the following detailed description of the invention, claims, and drawings.

### Technical Solution

In accordance with an aspect of the present invention, there is provided a method for detection of undifferentiated pluripotent stem cells, the method including:

(a) applying an electric pulse to stem cells; and

(b) measuring a cathodic peak potential (E_{pc}) of stem cells,

wherein, if an electrochemical signal of −0.155 V<E_{pc}<0.000 V is detected, it is determined that undifferentiated pluripotent stem cells are present.

The present inventors endeavored to develop a method for assessing the risk of teratoma formation from pluripotent stem cells used as stem cell therapeutic agents. As a result, the present inventors found that there is a specific cathodic peak potential (E_{pc}=−0.077 V) generated in undifferentiated pluripotent stem cells, and developed a method for detecting undifferentiated stem cells in mixed populations of differentiated cells and undifferentiated stem cells using the specific cathodic peak potential and further quantitatively analyzing undifferentiated stem cells. A method for detection of undifferentiated stem cells using electrochemical characteristics of the present invention, unlike FACS or real-time PCR requiring multiple steps for the entire process, is conveniently performed in a relatively short time and does not damage stem cells, thereby obtaining detection results with high reproducibility.

For teratoma-free stem cell therapy, a series of processes of accurate quantification of undifferentiated pluripotent stem cells (PSCs) and removal of residual undifferentiated PSCs is important after the end of the differentiation of stem cells. The general methods used therefor, such as fluorescent activated cell sorting (FACS) or real-time PCR analysis, have limitations in terms of their sensitivity and recyclability. The present inventors designed an in situ label-free monitoring system on the basis of a specific cathodic peak potential (E_{pc}) of PSCs in vitro using a cell chip technique. The present inventors observed that the E_{pc} of human embryonic stem cells (hESCs) and human induced pluripotent stem cells (hiPSCs) at −0.077 V disappeared after spontaneous differentiation.

Interestingly, the electric test used for monitoring did not markedly affect the proliferation rate and molecular characteristics of human aortic smooth muscle cells, which are blasts of hiPSC differentiation. It was observed that the specific E_{pc} completely disappeared after YM-155 treatment to ablate undifferentiated hPSCs, indicating that the detection of the specific E_{pc} of hPSCs would be a valid approach to monitor the contamination of undifferentiated hPSCc to assess the risk of teratoma formation efficiently and economically.

The present inventors found a specific cathodic peak potential (E_{pc}) of undifferentiated hPSCs, which were detected by a simple cell chip-based cyclic voltammetry technique. The cathodic peak current (i_{pc}) from undifferentiated hPSCs showed clear linearity (R²=0.99) to the number of undifferentiated hPSCs, implying that the number of undifferentiated hPSCs can be determined from the intensity of the signal in the cell chip. Considering that the blasts of hiPSC differentiation, that is, human aortic smooth muscle cells (hASMCs), to which the method of the present invention is applied, are still present and the gene expression and karyotypes thereof are not affected by electrochemical analysis, the technique of the present invention, which is a continuous monitoring method for confirming the safety of the cell therapy-based hPSCs, is ensured to be a safe and economical method that can be applied several times.

The method for detection of undifferentiated pluripotent stem cells of the present invention is for assess whether stem cells corresponds to a clinically or experimentally applicable stem cell population by ultimately confirming the presence of undifferentiated stem cells forming teratoma upon cell therapy. The present method may be used in the same meaning as the “method for specific detection of only undifferentiated stem cells in a cell sample containing undifferentiated pluripotent stem cells and differentiated cells”, “method for detection of undifferentiated pluripotent stem cells in a heterologous cell population containing undifferentiated stem cells”, or “method for measurement of the risk of teratoma formation”.

The stem cells, to which the present invention is applied, are stem cells that have characteristics of stem cells, that is, undifferentiation, infinite proliferation, and potency to differentiate into particular cells. The stem cells of the present invention are pluripotent stem cells, and include, for example, embryonic stem cells, induced pluripotent stem cells, embryonic germ cells, embryonic tumor cells, and adult stem cells. According to the present invention, the pluripotent stem cells are embryonic stem cells or induced pluripotent stem cells. Meanwhile, the pluripotent stem cells may be individual type single cells, or may be in the form of an embryoid-like body or embryonic body, which is an aggregate of pluripotent stem cells. The embryonic stem cells are derived from an inner cell mass (ICM) of the blastocyst, and the embryonic germ cells are derived from primordial germ cells of the gonadal ridge with an age of 5-10 weeks. Meanwhile, the pluripotent stem cells proliferate indefinitely in vitro, and have potency to differentiate into various cells derived from all three embryonic layers (ectoderm, mesoderm, and endoderm). The induced pluripotent stem cells are one type of pluripotent stem cells that are artificially derived from non-pluripotent cells (e.g., somatic cells) by inserting a particular gene. The induced pluripotent stem cells are considered to be the same as pluripotent stem cells (e.g., embryonic stem cells) since the induced pluripotent stem cells have stem cell gene and protein expression, chromosomal methylation, doubling time, embryonic body formation, teratoma formation, viable chimera formation, hybridizability, and differentiability.

Hereafter, the method for detection of undifferentiated pluripotent stem cells of the present invention will be described.

Step (a): Applying Electric Pulse

First, an electric pulse is applied to cells or a cell population to be analyzed.

Herein, an electric pulse is applied in a manner in which alternating current or voltage having an electric pulse is applied by bringing electrodes into contact with cells or a cell culture medium or immersing electrodes in cells or a cell culture medium. A current or voltage application device that can be used therefor is not particularly limited.

The cells or cell population corresponds to a differentiated mixture containing undifferentiated pluripotent stem cells (in which undifferentiated stem cells and differentiated cells are present together) or a product obtained by selecting and isolating differentiated cells from the differentiated mixture. The pluripotent stem cells are embryonic stem cells, induced pluripotent stem cells, embryonic germ cells, embryonic tumor cells, or adult stem cells.

For the stem cells, a conventional medium used for culturing stem cells in the conventional art may be used. For example, the medium includes mTeSR1 [(Ludwig, T. E. et al., Nature methods 3:637-646 (2006)], Eagle's MEM [Eagle's minimum essential medium, Eagle, H. Science 130:142 (1959)], α-MEM [Stanner, C. P. et al., NAT. New Biol. 230:52 (1971)], Iscove's MEM [Iscove, N. et al., J. Exp. Med. 147:923 (1978)], 199 medium [Morgan et al., Proc. Soc. Exp. BioMed., 73:1 (1950)], CMRL 1066, RPMI 1640 [Moore et al., J. Amer. Med. Assoc. 199:519 (1967)], F12[Ham, Pro. Natl. Acad. Sci. USA 53:288 (1965)], F10 [Ham, R. G. Exp. Cell Res. 29:515 (1963)], DMEM [Dulbecco's modification of Eagle's medium, Dulbecco, R. et al., virology 8:396 (1959)], DMEM and F12 mixture [Barnes, D. et al., Anal. Biochem. 102:225 (1980)], Way-mouth's MB752/1[Waymouth, C. J. Natl. Cancer Inst. 22:1003 (1959)], McCoy's 5A [McCoy, T. A., et al, Pro. Soc. Exp. Bio. Med. 100:115 (1959)], MCDB series [Ham, R. G et al., In Vitro 14:11 (1978)], and modified media thereof. The details of the media are described in R. Ian Freshney, Culture of Animal Cells, A Manual of Basic Technique, Alan R. Liss, Inc., New York, which is incorporated herein by reference in its entity.

According to an example of the present invention, hPSCs were cultured in mTeSR1 medium to minimize stress resulting from culture conditions. Meanwhile, the cells are preferably cultured in a feeder-free state while the detection procedure of the present invention is carried out.

Step (b): Measuring Cathodic Peak Potential

The cathodic peak potential (E_{pc}) of stem cells is then measured. If an electrochemical signal of “−0.155 V<E_{pc}<0.000 V” is detected, it may be determined that undifferentiated pluripotent stem cells are present.

According to the present invention, the cathodic peak potential (E_{pc}) of the stem cells was detected as having a lower value as the cell number increased. Originally, E_{pc} in a pure chemical material solution does not change as long as the concentration of the compound is not severely changed. However, due to the nature of the present measurement technique in which cells are attached directly to electrodes, the resistance value of the electrode is changed due to the attachment of the cells to the electrode, so that the E_{pc} shows a negative shift phenomenon as the cell number increases. The change into a negative voltage means that the energy or potential required for reduction is more and more required, and the cause thereof is presumed to be an increased electrode resistance value.

According to an embodiment of the present invention, when an electrochemical signal of “−0.155 V<E_{pc}<0.000 V” is detected at the measurement of the cathodic peak potential (E_{pc}), it may be determined that undifferentiated pluripotent stem cells are present. According to another embodiment of the present invention, the numerical range of the cathodic peak potential, which is detected in the presence of undifferentiated pluripotent stem cells, is “−0.135 V<E_{pc}<−0.020 “V”, “−0.120 V<E_{pc}<−0.035 V”, or “−0.110 V<E_{pc}<−0.050 V”. According to a particular embodiment of the present invention, the numerical range of the cathodic peak potential is −0.103 V<E_{pc}<−0.052 V. According to another particular embodiment of the present invention, the numerical value of the cathodic peak potential satisfies E_{pc}=−0.077 V. According to one example of the present invention, −0.077 V was measured most frequently and as the cell number increased, the highest voltage was −0.103 V, and for a small number of cells, −0.052 V was detected (see FIGS. 2B, 2C, and 4B).

The cathodic peak potential (E_{pc}) of a particular cell type results from a specific redox potential on cell surfaces due to different surface proteins. Considering a wide range of surface proteins of hPSCs compared with differentiated cells, the present inventor predicted that specific E_{pc} would be shown while hPSCs were maintained in an undifferentiated state. As predicted, the present inventors observed a specific E_{pc} of hPSCs, and the cathodic peak current (i_{pc}) thereof increased in proportion to the cell number (linearity of 0.99 or over) (see FIG. 2) and was dramatically reduced during differentiation (see FIG. 3). That is, according to the present invention, the cathodic peak current (i_{pc}) at the E_{pc} (e.g., −0.077 V) increases in proportion to the number of undifferentiated pluripotent stem cells.

The cathodic peak potential (E_{pc}) may be measured through voltammetry, which is one of available electroanalysis methods. Voltammetry is a method for obtaining a current-potential curve in a solid-state electrode or the like, wherein the electrode voltage is periodically changed using a triangular wave, thereby enabling understanding of the oxidation-reduction behavior of a compound and an electrode material in a solution. This is also called cyclic voltammetry (CV).

Meanwhile, electrochemical characteristics are significantly affected by the electrolyte composition, and therefore, it is desirable to use PBS to minimize unnecessary signals.

According to an example of the present invention, the cells were washed with PBS (0.01 M, PH 7.4) before electrochemical measurement, and CV detection was carried out at 0.1 V/s in the range of −0.2 V to 0.6 V by mTeSR1 (StemCell Technologies, #05850).

The undifferentiated pluripotent stem cells detected by the detection method of the present invention are stem cells in a step before complete differentiation, and therefore, embryonic bodies formed in a middle step before complete differentiation from stem cells into particular cells can also be detected.

In accordance with another aspect of the present invention, there is provided a method for quantitative analysis of undifferentiated pluripotent stem cells, the method including:

(a) applying an electric pulse to stem cells;

(b) measuring a signal of −0.155 V<E_{pc}<0.000 V as a cathodic peak potential (E_{pc}) of the stem cells; and

(c) quantifying undifferentiated pluripotent stem cells according to a cathodic peak current (i_{pc}) at the E_{pc}.

The cell population corresponds to a differentiated mixture containing undifferentiated pluripotent stem cells (undifferentiated stem cells and differentiated cells are present together) or a product obtained by selecting and isolating differentiated cells from the differentiated mixture. It is crucial to accurately assess the number of undifferentiated hPSCs in the differentiated mixture or even after isolated differentiated cells. Residual undifferentiated hPSCs are one of the serious risk factors in hPSC-based therapy because hPSCs can potentially lead to teratoma formation once engrafted in vivo for cell therapy.

The quantitative analysis of undifferentiated pluripotent stem cells is a very important step in assessing the risk of teratoma formation by undifferentiated pluripotent stem cells remaining after the end of differentiation. FACS assay using antibodies of specific surface markers (SSEA3, TRA-1-60, SSEA4, etc.) of undifferentiated pluripotent stem cells and RT-PCR assay using primers for specific genes (Oct-4, Sox2, Nanog, Lin28a, etc.) of differentiated pluripotent stem cells are currently used. However, the foregoing FACS and RT-PCR have disadvantages in that cells required for a differentiation procedure need to be separately differentiated since the cells used for analysis cannot be harvested. In addition, it is difficult to perform quantitative analysis of undifferentiated pluripotent stem cells several times as needed in each differentiation step, and additional costs are incurred for the differentiation process. In addition, as for FACS or RT-PCR using antibodies, complicated steps requiring 24 hours or longer are needed, the quantitative analysis of cells contained in a sample is impossible, and only a relative comparison between samples is possible.

However, the quantitative analysis method of the present invention does not use antibodies, thereby attaining fast quantitative analysis, and even after the analysis, the method of the present invention does not affect cell functions, so that the cells used for the analysis are collected prior to use for cell therapy or other analysis tests.

According to the present invention, the cathodic peak current (i_{pc}) increases in proportion to the number of undifferentiated pluripotent stem cells. As described above, E_{pc} may be measured through voltammetry, which is one of the electroanalysis methods, and in the present invention, a cyclic voltammetry technique was used. The cathodic peak current (i_{pc}) from undifferentiated hPSCs showed clear linearity (R²=0.99) to the number of undifferentiated hPSCs, implying that the number of undifferentiated hPSCs can be determined from the cathodic peak current (i_{pc}).

According to the present invention, the numerical range of cathodic peak potential, which is detected when undifferentiated pluripotent stem cells are present, is “−0.135 V<E_{pc}<−0.020 V”, “−0.120 V<E_{pc}<−0.035 V”, or “−0.110 V<E_{pc}<−0.050 V”.

According to the present invention, the pluripotent stem cells are embryonic stem cells, induced pluripotent stem cells, embryonic germ cells, embryonic tumor cells, or adult stem cells.

Since the method for quantitative analysis of the present invention uses the above-described method for detection of undifferentiated pluripotent stem cells, descriptions of overlapping contents between the two are omitted to avoid excessive complication of the specification due to repetitive description.

In accordance with another aspect of the present invention, there is provided a cell chip for detection of undifferentiated pluripotent stem cells, the cell chip including a substrate allowing cell accommodation or adsorption. When an electric pulse is applied to the cells and then a cathodic peak potential (E_{pc}) of the cells is measured, if the cathodic peak current (i_{pc}) at −0.155 V<E_{pc}<0.000 V at −0.155 V<E_{pc}<0.000 V (E_{pc}=−0.077 V in examples) is detected, it is determined that undifferentiated pluripotent stem cells are present.

According to the present invention, the numerical range of the cathodic peak potential detected when undifferentiated pluripotent stem cells are present is “−0.135 V<E_{pc}<−0.020 V”, “−0.120 V<E_{pc}<−0.035 V”, or “−0.110 V<E_{pc}<−0.050 V”.

As used herein, the term “substrate” refers to a solid substrate capable of accommodating cells. The substrate may be formed of an organic polymer or an inorganic material, and any substrate may be used as the substrate that may be used in the present invention irrespective of the surface characteristics thereof.

The organic polymer includes a polyamide homopolymer or copolymer (e.g., nylon), a heat-resistant plastic fluorinated polymer (e.g., polyvinylidene fluoride PVDF), a polyvinyl halide (e.g., polyvinyl chloride PVC), polysulfone, a cellulose material (e.g., paper, nitrocellulose, or cellulose acetate), polyolefin, polyacrylamide (e.g., poly(N-isopropylacrylamide)), polyglycolic acid (PGA), polylactic acid (PLA), polyglactin 910 (Vicryl® polyglyconate (Maxon™), polydioxanone (PDS), poly-4-hydroxybutyrate, carbon, carbon nanotubes, colloid, and a natural polymer (e.g., agarose or hyaluronan). The inorganic materials include glass, quartz, silica, silver, gold, aluminum, copper, titanium, other silicon-containing materials (e.g., silicon oxides or nitrides), metal oxides (e.g., aluminum oxides), metal alloys, Si/SiO₂ wafer, germanium, and gallium arsenide.

In the present invention, the metal that may be used as a solid substrate is not particularly limited, and any metal used in the art may be used. In addition, the surface shape, size, and chemical composition of the solid metal substrate used in the present invention are not particularly limited. As used herein, the term “solid metal substrate” has a meaning encompassing all of metals, metal oxides, and alloys. For example, the solid metal substrate that may be used in the present invention includes gold, silver, copper, platinum, copper, aluminum, titanium, alloys of the metals (e.g., an alloy of gold and copper), or a metal oxide substrate. The metal solid substrate includes not only a solid substrate made of a metal but also a substrate that is surface-coated with a metal. Meanwhile, the substrate is preferably transparent or semitransparent such that cells on the electrode can be easily observed using an optical microscope.

The cell chip of the present invention is a three-electrode system including a working electrode, a counter electrode, and a reference electrode. According to an embodiment of the present invention, the working electrode is composed of glass-titanium (Ti)-gold films in a direction from the lower layer to the upper layer. That is, the working electrode, for adhesion between gold and glass, may be fabricated by sputtering a titanium (Ti) film on glass and sputtering a gold film on the Ti. This substrate is in a semi-transparent state in which cells on the electrode can be easily observed using an optical microscope. In the examples of the present invention, the working electrode was Au, the counter electrode was Pt, and the reference electrode was Ag/AgCl.

Meanwhile, for immobilization of stem cells for electrochemical measurement on the cell chip, Matrigel is coated on the working electrode of the substrate, and cells are seeded and cultured on the Matrigel.

The cell chip of the present invention may further include a separate chamber for accommodating a cell culture in addition to the substrate.

The cathodic peak potential (E_{pc}) in the cell chip is measured in stem cells in the presence of mTeSR1.

Since the cell chip of the present invention uses the above-described method for detection of undifferentiated pluripotent stem cells and method for quantitative analysis of undifferentiated pluripotent stem cells, descriptions of overlapping content among these are omitted to avoid excessive complication of the specification due to repetitive description thereof.

### Advantageous Effects

The features and advantages of the present invention are summarized as follows:

(a) The present invention is directed to a method for detection of undifferentiated pluripotent stem cells and to a cell chip using the same.

(b) The method for cell chip-based quantitative analysis of the present invention does not use antibodies unlike the conventional FACS or the real-time PCR, which were used for quantitative analysis of pluripotent stem cells, and thus, convenient and fast quantitative analysis can be attained, and the method of the present invention does not affect cell functions even after analysis, and thus, the cells used for analysis can be collected and used.

(c) The detection method of the present invention uses a specific E_{pc} (−0.077 V) of hPSCs, so that the number of undifferentiated hPSCs can be quantitatively analyzed from the cathodic peak current (i_{pc}) increasing in proportion to the number of undifferentiated hPSCs.

(d) The cell chip-based E_{pc} assessment of the present invention is conducted in a relatively short time, leading to a convenient assessment, and can give high reproducibility with having a clear linearity (0.99 or over).

### BRIEF DESCRIPTION OF THE DRAWINGS

FIGS. 1A and 1B are schematic diagrams showing the establishment of a cell chip for in situ detection of hPSCs. FIG. 1A is a schematic diagram of a cell chip with working electrodes and shows an image of the cell chip accommodating hPSCs (left panel). FIG. 1B shows optical microscopic images of hPSCs on the cell chip on Day 1 and Day 4 after seeding of the cells on the cell chip. scale bar=400 μm.

FIGS. 2A to 2C show electrochemical detection and quantification analysis results of hPSCs. FIG. 2A shows cyclic voltammetry and cathodic peak current (i_{pc}, red arrow and line) results of 1.4×10⁵/hESCs (gray line) or 2.6×10⁵/hiPSCs (black line) (left panel). In addition, optical microscopic images of hESCs (H9) and hiPSCs (SES8) after alkaline phosphatase activity analysis were observed (shown in red, right panel). scale bar=200 μm. Meanwhile, cell number-dependent CV peak changes of hESCs (FIG. 2B, left panel) and hiPSCs (FIG. 2C, left panel) were observed. Each is shown by the scatter plot of CV peak current (i_{pc}) versus cell numbers and the linear regression analysis of E_{pc} versus cell numbers (right panels of FIGS. 2A and 2B). The cell numbers were 0.7×10⁵, 3.1×10⁵, and 6.5×10⁵ in FIG. 2B, and the cell numbers are 1.2×10⁵, 2.6×10⁵, and 4.5×10⁵ in FIG. 2C.

FIGS. 3A to 3E show specific i_{pc} of hPSCs. FIG. 3A shows the CV graph of hiPSC (red, uppermost and lowermost plot), hASMC (blue), and i-dSMC (black) (left panel); and the scatter plot of CV peak current versus cell numbers of hASMC (blue) or i-dSMC (black) compared with the cell number-dependent standard curve of hiPSC (red) (right panel). FIG. 3B shows a brief protocol for hiPSCs spontaneous differentiation. Images represent typical embryoid body (EB) and cells differentiated from EB (left bottom images) are shown, respectively. scar bar=200 μm and 500 μm. The right panel of FIG. 3B shows RT-PCR analysis results of Oct4, Nanog, Pax6 (ectoderm), Brachyury T (mesoderm), and Sox17 (endoderm) of hiPSCs and differentiated cells from hiPSCs (EB Dif.) for 7 days. FIG. 3C shows the CV graph of hiPSC (red, uppermost and lowermost plot) and differentiated cells (EB Dif, blue); and the scatter plot of CV peak current versus cell numbers of differentiated cells (EB Dif.) compared with the cell number-dependent standard curve of hiPSCs (red) (right panel). FIG. 3D shows a brief protocol for hESC spontaneous differentiation. The asterisk (*) indicates each day of sample harvest for mRNA expression and i_{pc} measurement. The optical microscopic images of hESCs and differentiated cells from hESCs (Dif.) on the cell chip are shown. scale bar=500 μm (left panel). The right panel of FIG. 3D shows real-time PCR analysis results for Oct4 or Nanog in each sample (0, 3, 6, and 7 days after differentiation). FIG. 3E shows a graph of CV peak current (blue, Y axis) and cell number (grey, Y axis) at indicative days of differentiation.

FIGS. 4A to 4E show i_{pc} detection results from hPSCs in mixed culture conditions. FIG. 4A shows an optical microscopic image (left panel, scale bar=200 μm), SSEA4 immunofluorescence images (red), and DAPI images (blue) of mixed cells of hiPSCs and hASMCs. SSEA4-positive regions were indicated by dotted lines. scale bar=100 μm. FIG. 4B shows CV peak changes depending on the cell number increase of fixed numbers of hASMCs and hiPSCs (left panel) and linear regression analysis results of i_{pc} cell numbers (right panel). The cell numbers of hiPSCs were 3.3×10⁴, 5.0×10⁴, 8.3×10⁴, and 11×10⁴, respectively. FIG. 4C shows PCR analysis results showing the scatter plots with linear regression (left panel) and nonlinear regression (right panel) of mRNA fold ratio versus mixed hiPSC population (%) of Oct4, Sox2, Nanog, and Lin28a. FIGS. 4D and 4E show cell proportions (%) of hiPSCs (FIG. 4D) and hESCs (FIG. 4E) mixed with hASMCs or human dermal fibroblasts (hDF). The reproducible percentage of the Oct4-(4D) or SSEA3-(4E) positive population was determined through FACS analysis and is presented by linear regression in the plot (right panels).

FIG. 5 shows the results of measuring the damage degree of smooth muscle cells after electrochemical measurement. FIG. 5A shows FACS analysis results of Annexin V and 7-AAD for detecting apoptotic populations of hASMCs 3 days after electrochemical measurement (P.C: positive control for inducing apoptosis). The annexin V-positive population under each condition was graphically presented (right panel). FIG. 5B shows the results of the proliferation rate with or without electric stimulation, determined using by IncuCyte FLR for additional 3 days. FIG. 5C shows immunoblotting assay results for PARP½ cleavage (arrow), cleaved caspase 3, and H2AX phosphorylation (pH2AX) with or without stimulation (P.C: positive control for inducing apoptosis). The α/β tubulin was used for an protein loading control. FIG. 5D shows optical microscopic (top panel, scale bar=200 μm) or immunofluorescent (bottom panel, α-SMA for green, DAPI for blue, bottom panel, scale bar=50 μm) images of hASMCs with or without stimulation. FIG. 5E shows real-time PCR analysis (left panel) or Immunoblotting assay (right panel) results for α-SMA with or without stimulation (NS: not significant, PCNA for protein loading control). FIG. 5 shows the karyotyping of hASMCs with or without stimulation.

FIGS. 6a to 6D show the validation of in situ monitoring of undifferentiated hPSCs for ensuring safety. FIG. 6A shows a graph of CV peak current (blue, right Y axis) and cell number (grey, left Y axis) of hiPSCs 24 h after does-dependent YM155 treatment. FIG. 6B shows the CV peak current of hESCs 24 h after does-dependent YM155 treatment. FIG. 6C shows a brief protocol of YM155 treatment (YM155 tx) in mixed culture conditions of hiPSCs and hASMCs (left panel). The optical images of hiPSCs and hAMSCs on the cell chip were observed 24 hour after treatment with 30 nM YM155 (Normal colony of hiPSCs was shown in black dotted line and altered morphology of hiPSC colony was shown in red dotted line (scale bar=500 μm). FIG. 6D shows the CV peak current measured 24 hours after treatment with YM155 for different doses in mixed culture conditions and the CV peak current of the equal number of untreated hASMCs.

FIG. 7 is a schematic diagram of the application of in situ monitoring of undifferentiated hPSCs.

FIG. 8a shows i_{pc} measurement results according to the number of hiPSCs under PBS conditions, and FIG. 8B shows the results that different E_{pc} values were observed for different cell types. hPSCs (−0.077 V), PC12 pheochromocytoma cells (0.13 V), MCF7 breast cancer cells (0.05 V), SH-SY5Y neuroblastoma cells (−0.10 V).

FIGS. 9A and 9B shows FACS analysis results for TRA-1-60 or SSEA3, which is a specific keratin sulfate antigen of hPSCs according to the cell proportion (%) of hiPSCs mixed with hASMCs. The linearity was similar (R2=0.995, TRA-1-60; R2=0.934, SSEA3).

FIG. 10 shows that, after 40 nM YM-55 treatment in mixed culture conditions of hESCs and differentiated cells derived therefrom, the apoptosis by active caspase-3 was shown in only the SSEA3+(positive) population, but not in SSEA3-(negative) population.

### MODE FOR CARRYING OUT THE INVENTION

Hereinafter, the present invention will be described in detail with reference to examples. These examples are only for illustrating the present invention more specifically, and it will be apparent to those skilled in the art that the scope of the present invention is not limited by these examples.

### Examples

### Materials and Methods

Compounds and Other Materials

Dulbecco's Phosphate buffered saline (DPBS) was purchased from StemCell Technologies Inc. (Vancouver, Canada). 4-well plastic chamber (Lab-Tek(R)) suitable for cell culture was obtained from Thermo fisher scientific (USA). The compounds used in the present invention were commercially purchasable.

Fabrication of Working Electrode

In the present invention, a general 3-electrode electrochemical system composed of a working electrode (Au), a counter electrode (Pt), and a standard electrode (Ag/AgCl) was introduced. The working electrode was prepared by sputtering of 5 nm-thick titanium (Ti) layer on glass and then sputtering of 50 nm-thick gold layer on Ti, for the attachment between gold and glass. This substrate was semi-transparent, whereby the cells on the electrode could be easily observed through an optical microscope. The electrode was washed by sonication in alcohol and distilled water for 5 min. Then, the gold electrode was immersed in a piranha solution (H₂SO₄: H₂O₂=7:3) for 5 min at 65° C. After the treatment with the piranha solution, the gold electrode was washed with 100% alcohol and distilled water. The electrode was finally electrochemically washed in 10 mM PBS until the stable cyclic voltammogram was obtained. For the electrochemical measurement, a plastic chamber (2 cm width, 2 cm length, 0.5 cm height) was fixed on the working electrode using polydimethylsiloxane (PDMS). For PSCs adsorption, Matrigel (BD Biosciences) was coated on the working electrode at 1:80 dilution in hESC basal medium (DMEM/F12 supplemented with 1% non-essential amino acids, 0.1% b-mercaptoethanol, and 0.1% gentamycin) for at least 1 hr. Matrigel (BD, #354277) diluted at 1:80 for 1 hr under DMEM-F12, was coated on the working electrode.

Cell Culture

hESCs (H9; Wicell Research Institute) and hiPSCs (SES8; (32)) were cultured in mTeSR1 medium (StemCell Technologies) under feeder-free conditions. hASMCs and i-dSMCs were cultured in smooth muscle cell-specific medium, SMCM (ScienCell Research Laboratories), and hDFs were cultured in DMEM medium (Gibco) supplemented with 10% FBS and 0.1% gentamycin. Alkaline phosphatase staining was performed according to the direction included in the Alkaline Phosphatase Kit (Sigma).

Electrochemical Detection

Cyclic voltammetry (CV) method was carried out using a CHIe660C Potentiostat (CH Instruments, Austin, Tex., USA). A fabricated chip, based on an Au electrode as a working electrode, an Ag/AgCl (1M KCl) as a reference electrode, and a Pt wire as a counter electrode was used. For the electrochemical measurement, cells were washed with PBS (0.01 M, PH 7.4). CV detection was performed between −0.2 V and 0.6 V at 0.1 V/s in mTeSR1 (StemCell Technologies, #05850). All measurements were replicated at least three times, and the cell number was calculated following detection.

Spontaneous Differentiation

Spontaneous differentiation was performed by two methods using either embryoid body formation or direct fetal bovine serum. To generate embryonic bodies, dissociated hiPSCs were maintained in a floating state using hESC basal medium containing 20% serum replacement (SR). The generated embryonic bodies were attached on a cell culture plate in DMEM medium and then cultured for the indicated days. For direct FBS differentiation, mTeSR1 medium was replaced with DMEM 3 days after cell attachment, and differentiated for the indicated days.

RNA Extraction and Real-Time PCR

RNA was obtained using RNA Extraction Kit (Intron), and 500 ng of RNA was converted to complementary DNA (cDNA) using Prime Script RT Master Mix (Takara) in accordance with the provided method. Real-time PCR was performed using SYBR Premix Ex Taq (Takara) on the LightCycler 480 instrument II (Roche). The gene-specific primers used in the present invention are shown in Table 1.

TABLE 1
Primer sequences

| Gene | Forward sequence | Reverse sequence |
|---|---|---|
| POU5F1 | 5-CCCCAGGGCCCCATTTTGGTACC-3 | 5-ACCTCAGTTTGAATGCATGGGAGAGC-3 |
| NANOG | 5-AAATTGGTGATGAAGATGTATTCG-3 | 5-GCAAAACAGAGCCAAAAACG-3 |
| SOX2 | 5-TTCACATGTCCCAGCACTACCAGA-3 | 5-TCACATGTGTGAGAGGGGCAGTGTGC-3 |
| LIN28A | 5-CACGGTGCGGGCATCTG-3 | 5-CCTTCCATGTGCAGCTTACTC-3 |
| PAX6 | 5-TGTCCAACGGATGTGTGAGT-3 | 5-TTTCCCAAGCAAAGATGGAC-3 |
| T | 5-ACCCAGTTCATAGCGGTGAC-3 | 5-CCATTGGGAGTACCCAGGTT-3 |
| SOX17 | 5-AGCAGAATCCAGACCTGCAC-3 | 5-TTGTAGTTGGGGTGGTCCTG-3 |
| ACTA2 | 5-CATCACCAACTGGGACGACATGGAA-3 | 5-GCATAGCCCTCATAGATGGGGACATTG-3 |
| ACTB | 5-GTCCTCTCCCAAGTCCACAC-3 | 5-GGGAGACCAAAAGCCTTCAT-3 |
| GAPDH | 5-AAGGGTCATCATCTCTGCCC-3 | 5-GTGATGGCATGGACTGTGGT-3 |

Immunostaining and Immunoblotting

Cells were fixed with 4% paraformaldehyde and then permeabilized with 0.1% Triton X-100. After blocking with TBS-T containing 3% bovine serum albumin (BSA), the cells were incubated using the indicated primary antibody. The cells were washed and then incubated using either Cy2-(Jackson ImmunoResearch Laboratories) or Alexa 594-(Life Technologies) conjugated secondary antibody. Nuclei were stained with DAPI. Images were analyzed using a BX53 research microscope, and the following primary antibodies were used: SSEA4 (1:400, R&D Systems) and α-Smooth Muscle Actin (1:100, Sigma). Immunoblotting analysis was performed as described in the paper references above, and the following primary antibodies were used: PCNA and PARP½ (Santa Cruz), Cleaved Caspase 3, P-Histone H2A.X (S139), and α/β tubulin (Cell Signaling) and α-Smooth Muscle Actin (Sigma).

FACS Analysis and Apoptosis Assay

Cells were stained with respective fluorescent-labeled antibodies and analyzed using FACSCalibur (BD Biosciences). The following antibodies were used: Oct4 (Abcam), FITC Rat Anti-SSEA3 and PE Mouse Anti-Human TRA-1-60 (BD Pharminogen). For apoptosis assays, cells were stained using the PE Annexin V Apoptosis Detection Kit and the PE Active Caspase-3 Apoptosis Kit (BD Pharminogen) according to the manufacturer's direction.

Growth Curve Measurement and G-Band Karyotyping

The cell growth rate of hASMCs with or without electric stimulation was determined at 3-hr intervals for 3 days on the IncuCyte FLR (Essen Bioscience). For karyotyping, hAMSCs were incubated with 100 ng/ml colcemid for 2 hr and then sampled. The samples were organized in a hypotonic condition using 1% sodium citrate, followed by fixation using Carnoy's solution. The karyotypes were determined through G-banding.

Statistical Analysis

Graphical data were presented as mean±s.d. Statistical significance among three groups or more was determined using one- or two-way analysis of variance (ANOVA) and the statistical significance between two groups was analyzed through Student's t-test.

### Results

Establishment of Cell Chip for In Situ Detection of hPSCs

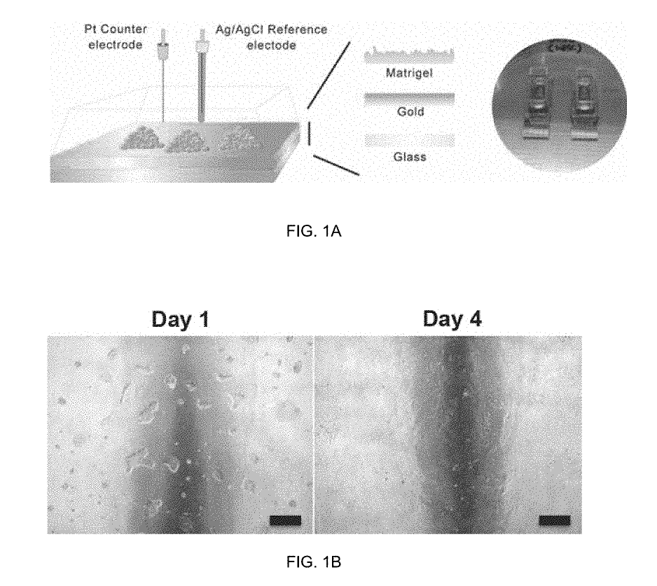

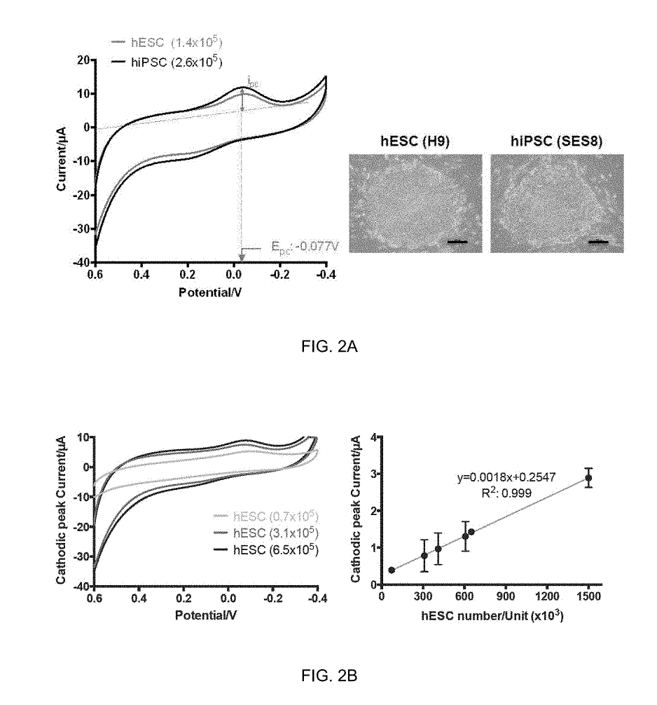

The present inventors designed an electrochemical cell chip based on a three-electrode system (27, 28). The cell chip was composed of a reference electrode (Ag/AgCl) and a counter electrode (Pt), placed on a platinum working electrode (FIG. 1A, left panel). hPSCs were cultured on the Matrigel/gold-coated plate with a transparent plastic cover (FIG. 1A, right panel). When either hESCs or hiPSCs were plated onto the cell chip, cells were well cultured in feeder-free conditions for at least 4 days while the entire process was conducted (FIG. 1B). The cell chip system was used to detect a specific E_{pc} of undifferentiated hPSCs by varying an electric pulse.

Electrochemical Detection and Quantification of hPSCs

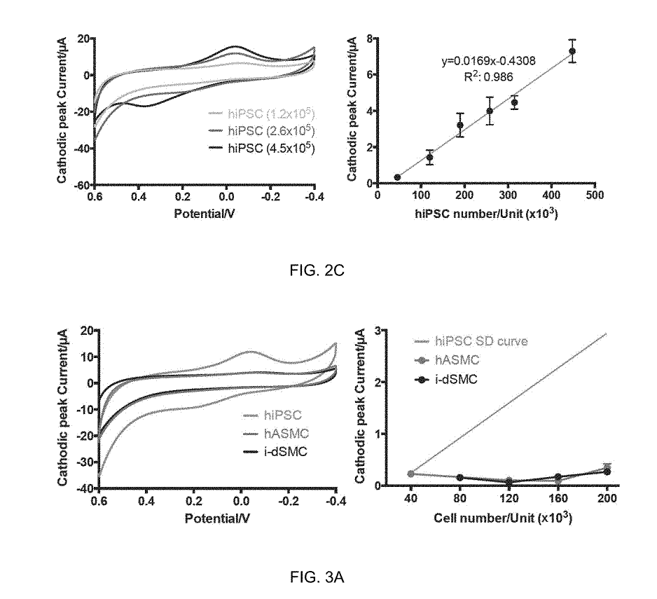

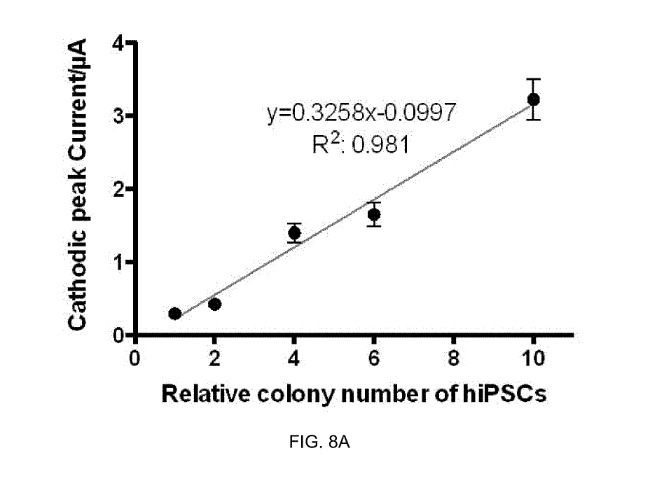

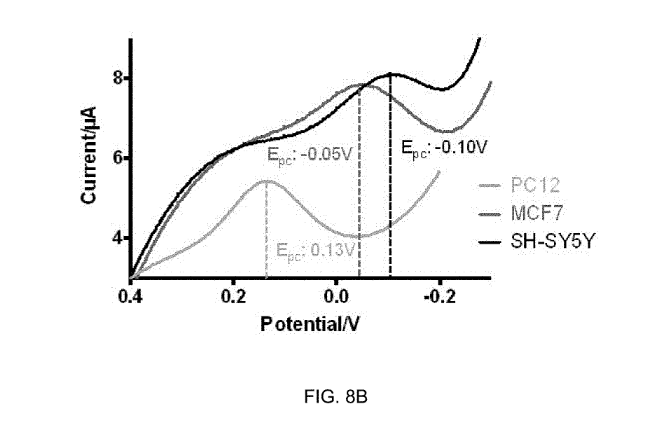

Electrochemical characteristics are strongly affected by the electrolyte composition, and therefore, it is desirable to use PBS to minimize unnecessary signals (28). However, unlike other human cell lines, hPSCs are vulnerable to stress caused by culture conditions, and thus, hPSCs were cultured in mTeSR1 medium (29, 30) before use in the experiment. E_{pc} of hESCs (H9: left panel) and hiPSCs (SES8: right panel), which were identified by alkaline phosphatase activity staining, was detected at 0.077 V (FIG. 2A). This specific signal was similarly observed under PBS conditions, suggesting that the E_{pc} of hPSCs is not dependent on the composition of the medium (FIG. 8A). The most important matter is that different E_{pc} values were observed for different cell types, such as PC12 pheochromocytoma cells (at 0.13 V), MCF7 breast cancer cells (at 0.05 V), or SH-SY5Y neuroblastoma cells (at −0.10 V), meaning that the E_{pc} value of hPSCs is shown in an hPSC-specific manner (FIG. 8B).

In addition, the cathodic peak current (i_{pc}) of hPSCs detected at −0.077 V increased in proportion to the cell number (70,000-650,000 cells). The linearity of the correlation between the cathodic peak current (i_{pc}) and the cell number was 0.999 (hESCs, FIG. 2B) and 0.986 (hiPSCs, FIG. 2C), respectively, indicating the linearity of the cathodic current peak according to the cell number.

Specific i_{pc} of hPSCs

The high linearity of i_{pc} with cell number (over 0.98) may be advantageously used to determine the cell number by simply measuring i_{pc} at −0.077 V, observed in hPSCs. Finally, for E_{pc} comparison, the present inventors used hiPSCs, human aortic smooth muscle cells (hASMCs), blasts of hiPSCs, and hiPSCs-derived smooth muscle cells (idSMCs), all of which share the same genetic background.

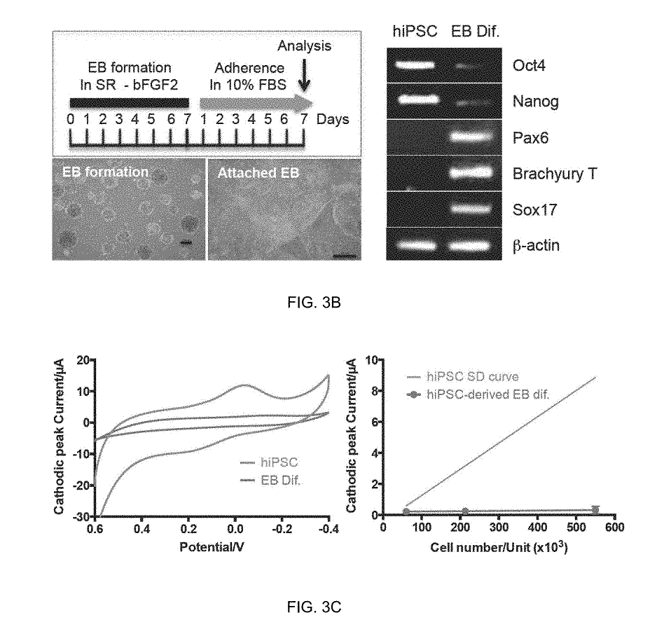

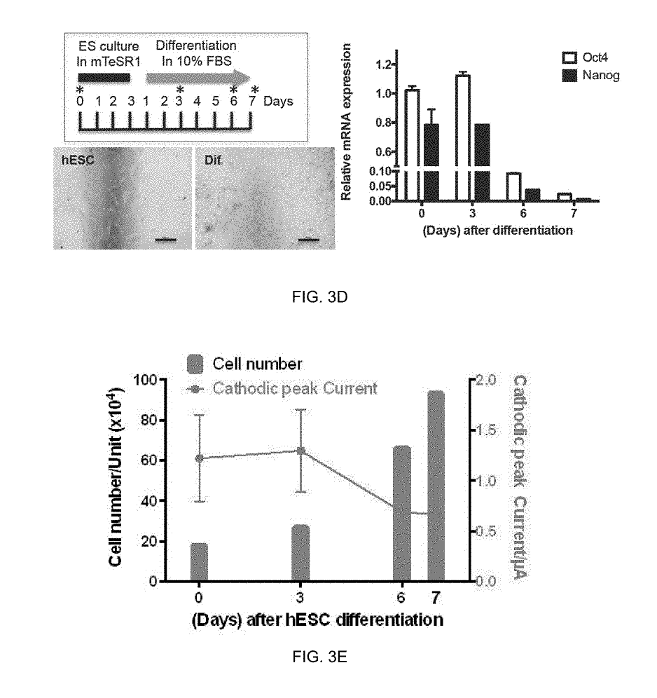

The same number of hiPSCs, hASMCs, and i-dSMCs (200,000 cells) were plated onto the cell chip, and i_{pc} measurement was conducted. As shown in FIG. 3A, the i_{pc} was detected only in hiPSCs, but not in hASMCs or i-dSMCs. These results mean that the E_{pc} of hPSCs shown in FIG. 2A is a signal specific to undifferentiated hPSCs. When the cell number of hASMCs and i-dSMCs gradually increased, no significant signal was observed (FIG. 3A, right panel).

To exclude the possibility that the lack of the i_{pc} in hASMCs or idSMCs is due to the characteristics of smooth muscle cells, hiPSCs were subjected to spontaneous differentiation into 3 kinds of germ layers for 14 days (FIG. 3B, left panel) (33). The germ layers were confirmed through the expression of respective specific marker genes (Pax6 for ectoderm, Brachyury T for mesoderm, and Sox17 for endoderm) (FIG. 3B, right panel). Interestingly, the i_{pc} from the differentiated cells of hiPSCs again disappeared (FIG. 3C, left panel). Despite the continuously increasing cell number (550,000 cells), the signal intensity from differentiated cells remained low (FIG. 3C, right panel). Similar results were also observed in hESCs. For 10 days, the spontaneous differentiation of hESCs resulted in dramatic reductions in the expression of Oct4 and Nanog in a time-dependent manner (FIG. 3D, right panel). The i_{pc} (blue) was markedly decreased in a differentiation-dependent manner while the total cell number (grey) was increased (FIG. 3E). Therefore, the present inventors determined that the E_{pc} of hPSCs detected at 0.077 V in the cell chip is a signal specific to undifferentiated hPSCs.

Detection of i_{pc} from hPSCs in Mixed Culture Conditions

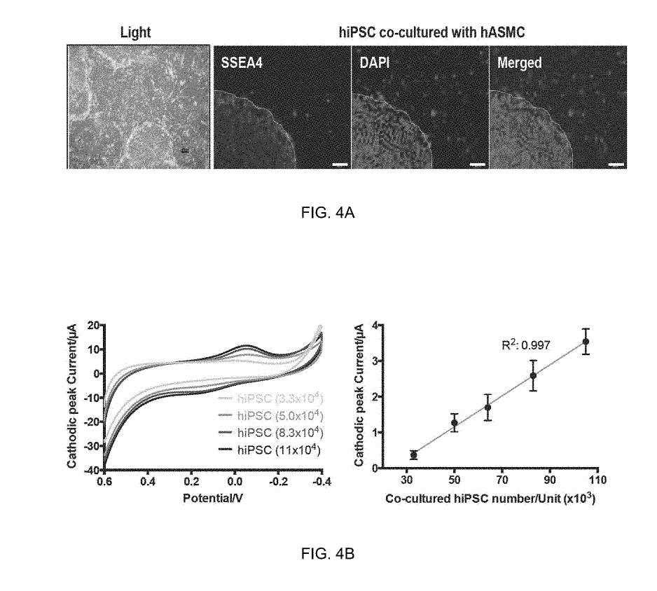

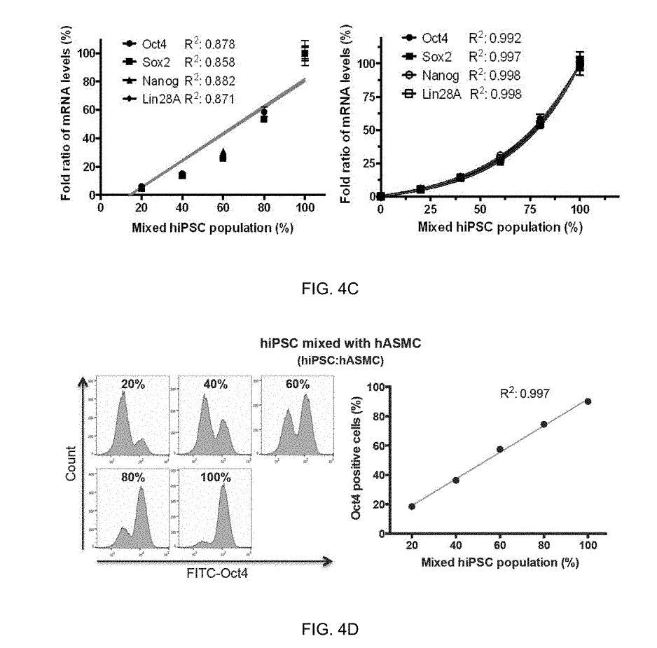

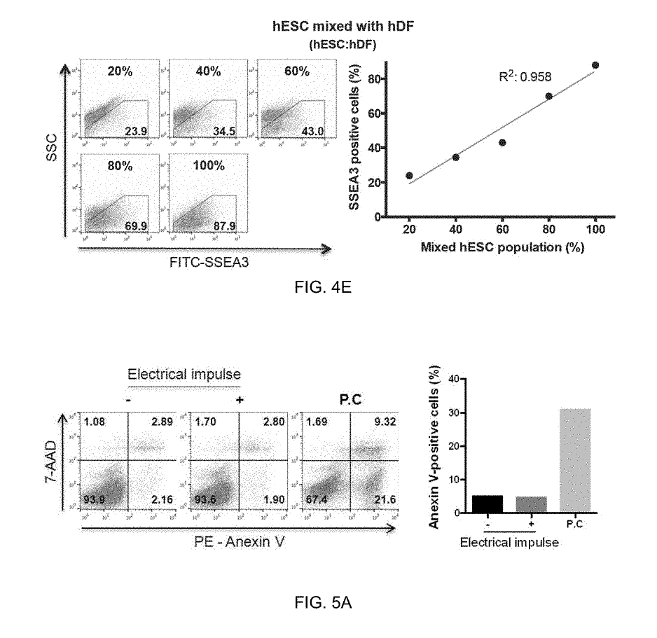

Residual undifferentiated hPSCs are a serious risk factor in hPSC-based therapy because hPSCs can potentially lead to teratoma formation once engrafted in vivo for cell therapy (4). Therefore, it is crucial to quantitatively assess the number of undifferentiated hPSCs in a differentiated mixture or even after cell sorting. Depending on the circumstances, additional processes for removing residual undifferentiated hPSCs using small molecules (23, 33) or hPSC-specific antibodies (34) may be needed. For verification thereof, the specific i_{pc} from hPSCs should be detectable in mixed culture conditions. To prove that the detection of the i_{pc} of hPSCs in mixed cultures is a valid means to assess the number of undifferentiated hPSCs, an indicated number of hiPSCs was co-cultured with a certain number of hASMCs to mimic the presence of undifferentiated hPSC after differentiation. As a result, as shown in FIG. 4A, undifferentiated hiPSCs were clearly distinguished by stage-specific embryonic antigen 4 (SSEA4) staining in mixed culture conditions (dotted line, FIG. 4A). As the number of undifferentiated hiPSCs co-cultured in a given number of hASMCs was gradually increased, the i_{pc} was, still, proportionally increased (R²=0.997, FIG. 4B, right panel). These results mean that the signal from undifferentiated hPSCs is not affected by differentiated cells.

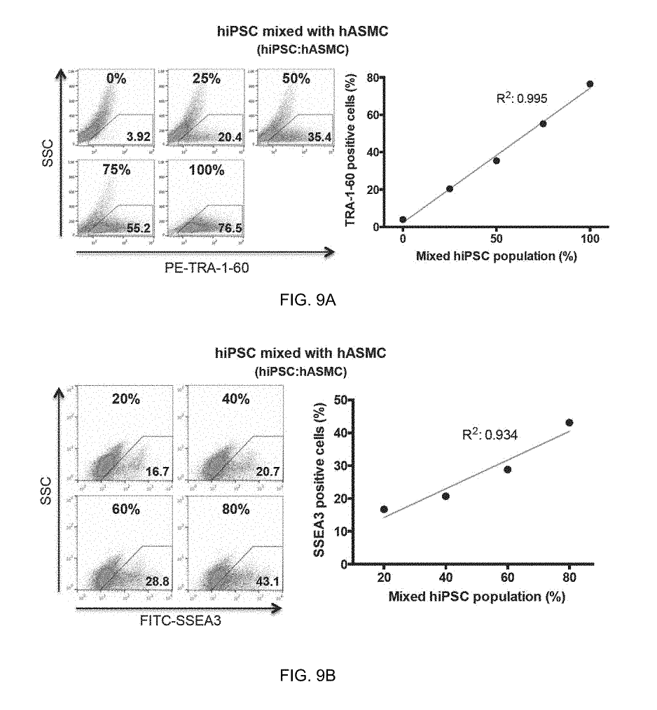

Next, the reliability of the cell chip of the present invention was compared with that in the current quantification method for undifferentiated hPSCs, namely, real-time PCR and FACS. Lin28 homolog A (Lin28a), which is a highly conserved RNA binding protein, is a marker of undifferentiated hPSCs after differentiation into retinal epithelial cells (35), which are currently in clinical trials for the treatment of macular degeneration. Although the levels of Lin28a and other typical pluripotent cell specific markers, namely, Oct4, Sox2, and Nanog, gradually increased while the percentage of undifferentiated hPSCs in the cell mixture increased, the linearity of the fold change in these mRNA levels was lower than the linearity observed with the cell chip (R², 0.88) (FIG. 4C, left panel). Rather, the fitting of the fold change in mRNA levels was apparently close to the sigmoid curve (R², 0.9981) (FIG. 4C, right panel). FACS analysis using Oct4 (hiPSCs, FIG. 4D) and SSEA-3 (hESCs, FIG. 4E), which is a typical undifferentiated surface marker (31), was performed to determine the linearity of the Oct4- or SSEA3-positive population with according to the percentage of undifferentiated hPSCs in the mixed culture. As shown in FIGS. 4D and 4E, the linearity of FACS analysis for the cell number was over 0.95 (R²=0.997 for Oct-4; and R²=0.958 for SSEA-3), which was equivalent to the linearity of a cell chip. Similar linearity was obtained even in FACS analysis using other antibodies in hiPSCs mixed with hASMCs (R²=0.995, TRA-1-60; R²=0.934, SSEA3) (see FIGS. 9A and 9B).

Smooth Muscle Cells are not Damaged after Measurement

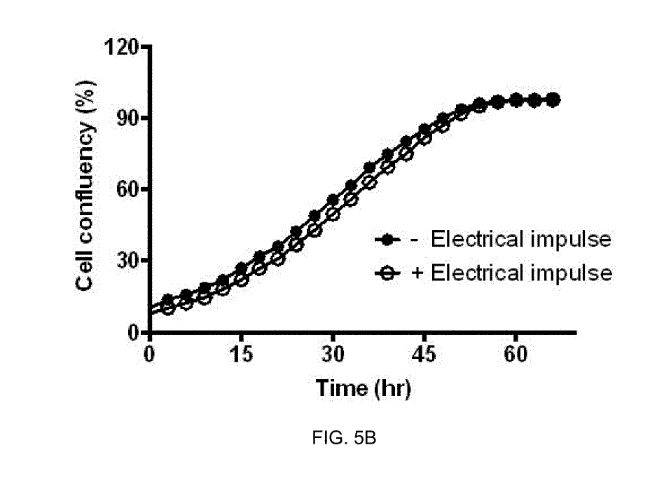

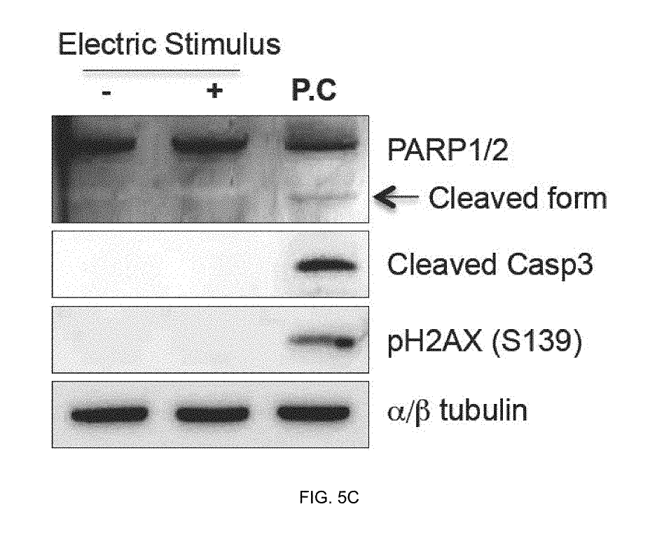

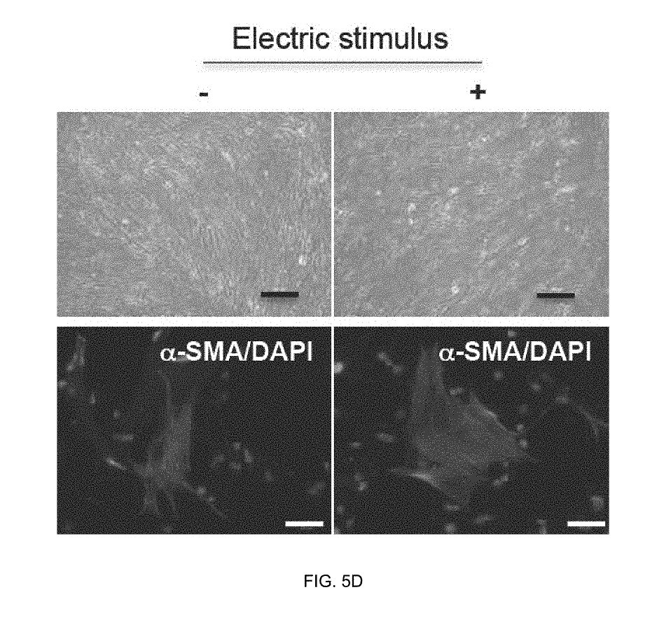

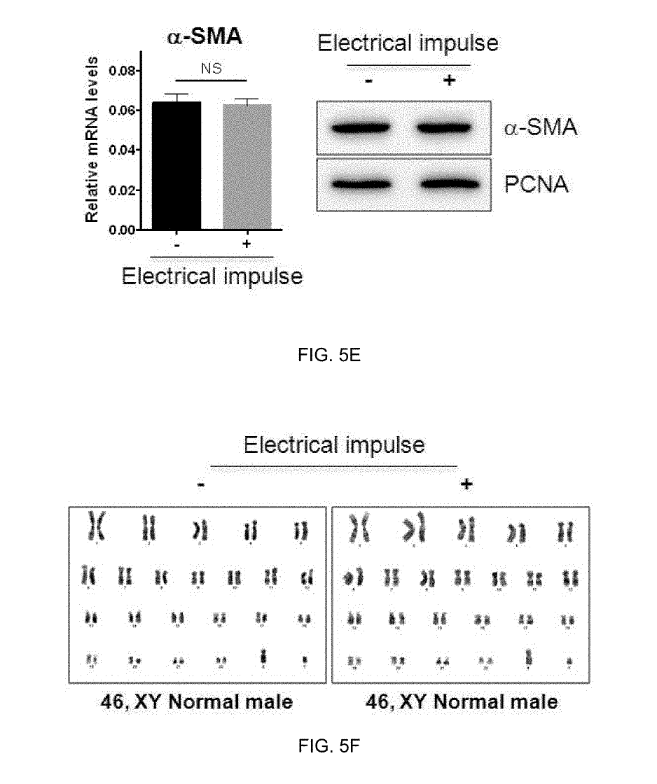

Unlike a large number of cells that are unrecoverably lost in FACS and real-time PCR analyses, the cells on the cell chip remained viable even after measurement, and thus it could be expected that the electric pulse used in the cell chip of the present invention does not cause great damage to the cells. In particular, after measurement, the degree of damage was analyzed by modeling the differentiated cells for the continuous use of differentiated cells. First, there was no apoptotic response by an electric pulse in hASMCs (FIG. 5A). In addition, hASMCs still actively proliferated after the electric measurement, suggesting that the electric pulse used during the measurement procedure minimally affected hASMC growth and survival (FIG. 5B). Next, the cellular stress response to the electrical charge, which may cause undesirable effects on cellular functions, was further examined by determining the phosphorylation level of Histone H2AX, which is increased by DNA damage (e.g., ultraviolet and ionizing radiation), oxidative stress (e.g., reactive oxygen species), osmotic stress (37-39), and the formation of active caspase 3. As a result, neither active caspase 3 nor phosphorylated H2AX was observed following application of the electric pulse (FIG. 5C). Furthermore, there were no noticeable changes in the morphology of hASMCs after application of the electric pulse; the level of α-smooth muscle actin (α-SMA), which is a typical molecular marker of hASMCs, remained constant (FIGS. 5D and 5E) and the karyotype remained normal (FIG. 5F). Therefore, the present inventors confirmed that hASMCs remain normal even after cell chip measurement, and thus, these cells can be used for cell therapy.

In Situ Monitoring Validation of Undifferentiated hPSCs for Ensuring Safety

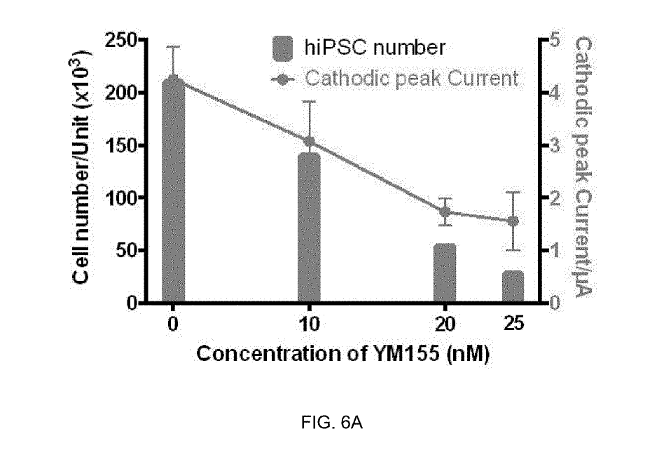

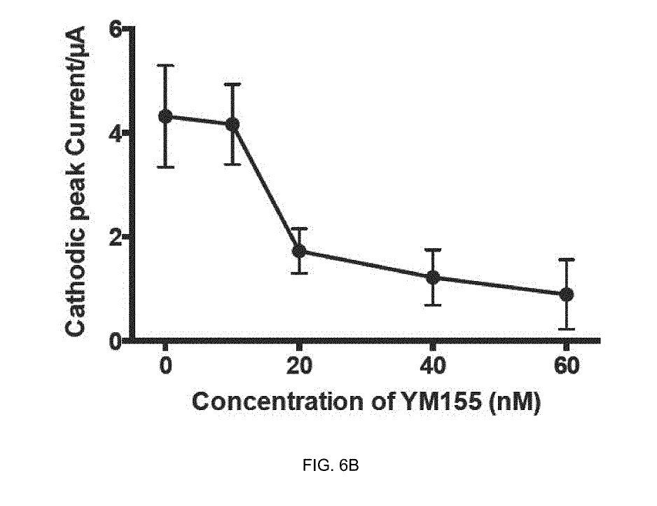

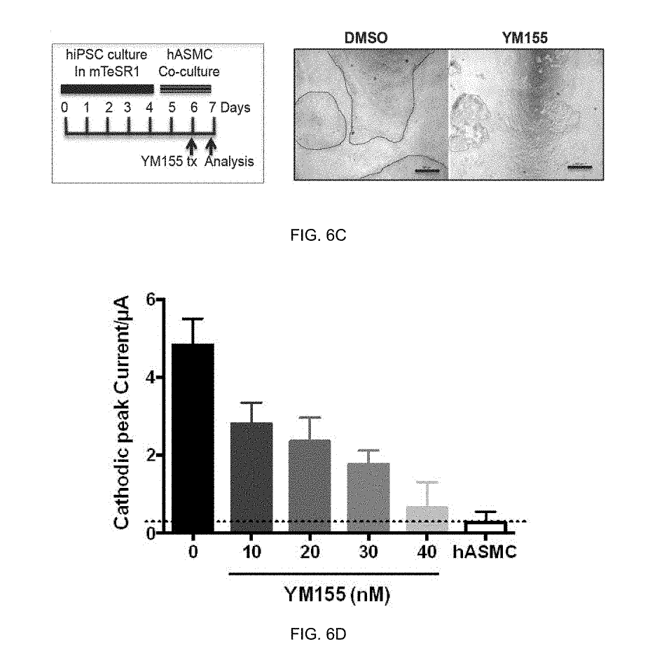

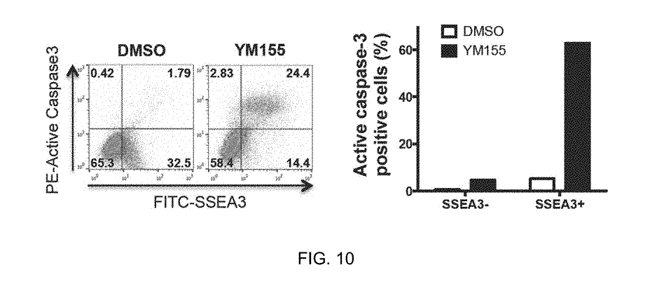

The present inventors reported two kinds of small molecules for inducing the selective apoptosis of undifferentiated hPSCs in previous studies (33). Therefore, it was predicted that, due to the induction of apoptosis by YM-155, treatment with YM-155 would decrease the number of hPSCs and thereby lower the i_{pc}. As predicted, YM-155 treatment markedly reduced the number of cells and the i_{pc} in a dose-dependent manner (FIG. 6A, hiPSCs; and FIG. 6B, hESCs). Label-free cell chip-based quantification of residual undifferentiated hPSCs may be applied at the end stage, which is critical to determine whether any additional treatment of undifferentiated cells is required in order to ensure safety of tumor-free cell therapy. To mimic this situation, hiPSCs were co-cultured with hASMCs. After the co-culture in the cell chip, hiPSCs still maintained the specific colony morphology of hPSCs (FIG. 6C, left panel, black dotted line), but after 24 h of YM155 treatment, there was a typical colony morphology in hiPSCs but not in hASMCs (FIG. 6C, right panel, red dotted line). After YM155 treatment, apoptosis by active caspase 3 was shown in only SSEA3-positive populations, not in SSEA3-negative populations (FIG. 10). This Indicates that the cell morphological changes on the cell chip after YM-155 treatment were due to the hiPSC-specific apoptosis. Under this condition, the i_{pc} upon the co-culture of hiPSCs and hASMCs gradually decreased in a dose-dependent manner of YM-155 (FIG. 6D). In particular, upon treatment with 40 nM YM155, the i_{pc} level was as low as that of hASMCs, suggesting that hiPSCs were markedly reduced in 40 nM YM155, consistent with previous studies (19).

The above-described data show effective methodology suggesting that the cell chip invented by the present inventors was able to prevent the formation of teratoma at the end of differentiation by confirming the presence of undifferentiated hPSCs through the assessment of the specific i_{pc} of hPSCs.

### DISCUSSION

The in vivo tumorigenicity of hPSCs is due to the intrinsic cancer-like properties of hPSCs (e.g., high telomerase activity and active cell cycle), and this tumorigenicity remains as an important barrier in PCS-based cell therapy. In order to solve the problem, many methods of inducing the selective apoptosis of residual undifferentiated hPSCs after differentiation using hPSC-specific antibodies and small molecules have been attempted. However, even after hPSCs were removed, an additional step for the successful removal of hPSCs is required for clinical applications. However, a current technique for determining the presence of hPSCs, such as real-time PCR or FACS, consume a large number of cell populations, which would otherwise be available for use in cell therapy.

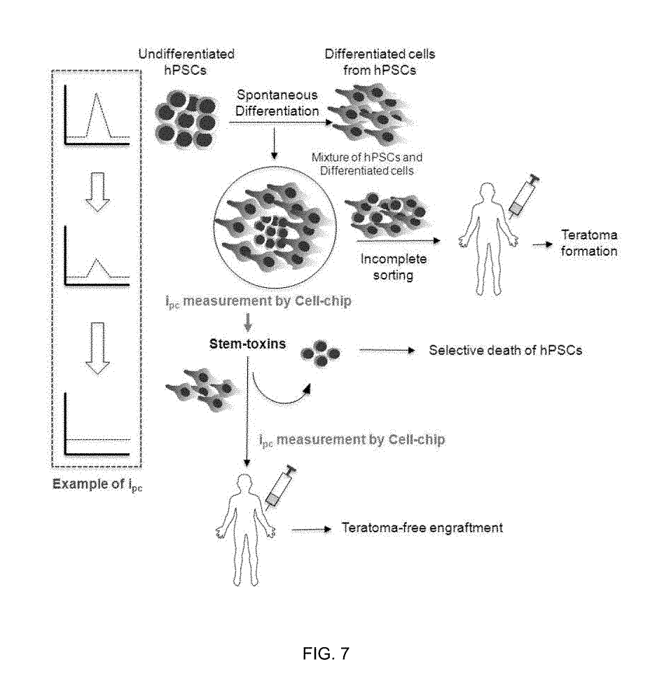

The E_{pc} of a given cell type may result from the specific redox potential of cell surfaces due to different surface proteins (46). Considering a wide range of specific surface proteins of hPSCs in comparison to their differentiated cells, it could be speculated that hPSCs exhibit specific E_{pc} while the hPSCs maintain the undifferentiated state (34, 40). As predicted, the present inventors observed a specific E_{pc} of hPSCs, the i_{pc} of which was highly proportional to the cell number (linearity of 0.99 or over) (see FIG. 2) and was dramatically reduced during differentiation (see FIG. 3). Most importantly, the signal intensity remained high even in co-culture condition (FIG. 4B). The hPSC-specific i_{pc} in the mixed cell population after differentiation provided information about the possible presence of teratoma-forming cells (undifferentiated hPSCs) (see FIG. 7). Once a particular i_{pc} level is detected, this indicates the presence of residual hPSCs, and an additional step can be performed to selectively remove hPSCs using “stem-toxics”, as previously reported by the present inventors, to ensure the safety of cell therapy (see FIG. 7).

Unlike FACS and real-time PCR analysis in which the entire process is composed of multiple steps, the assessment of i_{pc} on the basis of a cell chip is conducted in a relatively short time, thereby obtaining highly reproducible results with clear linearity. Meanwhile, determining the cycle threshold (Ct) value of real-time PCR for Lin28 is highly sensitive in the analysis of a single hPSC (35). However, according to FIG. 4C, real-time PCR analysis of hPSC-specific markers, including Lin28a, has lower linearity than the cell chip-based assay and FACS (FIG. 4). Therefore, the real-time PCR analysis is less suitable for accurately determining the number of hPSCs in mixed populations. Instead, it has been reported that hPSC-specific fluorescent probes (41) and hyperglycosylated podocalyxin secreted in hPSCs (26) are suitable for the detection of hPSCs in mixed populations. Indeed, the i_{pc} value of hPSCs showed high linearity and reproducibility (see FIG. 4), and may be applied to develop a new type of electronic device for measuring the number of hPSCs. Further, subsequent studies to improve the sensitivity of i_{pc} measurement by optimizing the organization of the cell chip to maximize the redox state in hPSCs are urgently required (47). The i_{pc} was currently detectable in as few as 30,000 hPSCs (FIG. 4B), which is close to the minimum number of hPSCs required to develop teratoma in a rodent model (42).

Taken together, the present inventors demonstrated the specific i_{pc} of hPSCs showing high linearity with the cell number using cell chip-based assay. The i_{pc} measurement after cell differentiation or an additional step to remove hPSCs would provide an important index for teratoma-free engraftment of hPSC-derived cells in the future.

Although the present invention has been described in detail with reference to specific features thereof, it will be apparent to those skilled in the art that this description is only for a preferred embodiment and does not limit the scope of the present invention. Thus, the substantial scope of the present invention will be defined by the appended claims and equivalents thereof.

### REFERENCES

1. Robinton, D. A. & Daley, G. Q. The promise of induced pluripotent stem cells in research and therapy. Nature 481, 295-305 (2012).
2. Lerou, P. H. & Daley, G. Q. Therapeutic potential of embryonic stem cells. Blood Rev 19, 321-331 (2005).
3. Araki, R. et al. Negligible immunogenicity of terminally differentiated cells derived from induced pluripotent or embryonic stem cells. Nature 494, 100-104 (2013).
4. Lee, A. S., Tang, C., Rao, M. S., Weissman, I. L. & Wu, J. C. Tumorigenicity as a clinical hurdle for pluripotent stem cell therapies. Nature Medicine 19, 998-1004 (2013).
5. Blum, B. & Benvenisty, N. The tumorigenicity of human embryonic stem cells. Advances in Cancer Research, Vol 100 100, 133-+(2008).
6. Cunningham, J. J., Ulbright, T. M., Pera, M. F. & Looijenga, L. H. J. Lessons from human teratomas to guide development of safe stem cell therapies. Nature Biotechnology 30, 849-857 (2012).
7. Ben-David, U. & Benvenisty, N. The tumorigenicity of human embryonic and induced pluripotent stem cells. Nature Reviews Cancer 11, 268-277 (2011).
8. Brederlau, A. et al. Transplantation of human embryonic stem cell-derived cells to a rat model of Parkinson's disease: Effect of in vitro differentiation on graft survival and teratoma formation. Stem cells 24, 1433-1440 (2006).
9. Arnhold, S., Klein, H., Semkova, I., Addicks, K. & Schraermeyer, U. Neurally selected embryonic stem cells induce tumor formation after long-term survival following engraftment into the subretinal space. Investigative Ophthalmology & Visual Science 45, 4251-4255 (2004).
10. Moon, J. et al. Stem Cell Grafting Improves Both Motor and Cognitive Impairments in a Genetic Model of Parkinson's Disease, the Aphakia (ak) Mouse. Cell Transplantation 22, 1263-1279 (2013).
11. Fujikawa, T. et al. Teratoma formation leads to failure of treatment for type I diabetes using embryonic stem cell-derived insulin-producing cells. American Journal of Pathology 166, 1781-1791 (2005).
12. Bjorklund, L. M. et al. Embryonic stem cells develop into functional dopaminergic neurons after transplantation in a Parkinson rat model. Proceedings of the National Academy of Sciences of the United States of America 99, 2344-2349 (2002).
13. Erdo, F. et al. Host-dependent tumorigenesis of embryonic stem cell transplantation in experimental stroke. Journal of Cerebral Blood Flow and Metabolism 23, 780-785 (2003).
14. Doi, D. et al. Prolonged Maturation Culture Favors a Reduction in the Tumorigenicity and the Dopaminergic Function of Human ESC-Derived Neural Cells in a Primate Model of Parkinson's Disease. Stem cells 30, 935-945 (2012).
15. Ben-David, U. & Benvenisty, N. Chemical ablation of tumor-initiating human pluripotent stem cells. Nature Protocols 9, 729-740 (2014).
16. Choo, A. B. et al. Selection against undifferentiated human embryonic stem cells by a cytotoxic antibody recognizing podocalyxin-like protein-1. Stem cells 26, 1454-1463 (2008).
17. Tan, H. L., Fong, W. J., Lee, E. H., Yap, M. & Choo, A. mAb 84, a cytotoxic antibody that kills undifferentiated human embryonic stem cells via oncosis. Stem Cells 27, 1792-1801 (2009).
18. Ben-David, U., Nudel, N. & Benvenisty, N. Immunologic and chemical targeting of the tight-junction protein Claudin-6 eliminates tumorigenic human pluripotent stem cells. Nature Communications 4 (2013).
19. Lee, M. O. et al. Inhibition of pluripotent stem cell-derived teratoma formation by small molecules. Proceedings of the National Academy of Sciences of the United States of America 110, E3281-E3290 (2013).
20. Schuldiner, M., Itskovitz-Eldor, J. & Benvenisty, N. Selective ablation of human embryonic stem cells expressing a “suicide” gene. Stem Cells 21, 257-265 (2003).
21. Rong, Z. L., Fu, X. M., Wang, M. Y. & Xu, Y. A Scalable Approach to Prevent Teratoma Formation of Human Embryonic Stem Cells. Journal of Biological Chemistry 287, 32338-32345 (2012).
22. Cunningham, J. J., Ulbright, T. M., Pera, M. F. & Looijenga, L. H. Lessons from human teratomas to guide development of safe stem cell therapies. Nat Biotechnol 30, 849-857 (2012).
23. Ben-David, U. & Benvenisty, N. Chemical ablation of tumor-initiating human pluripotent stem cells. Nat Protoc 9, 729-740 (2014).
24. Goldring, C. E. et al. Assessing the safety of stem cell therapeutics. Cell Stem Cell 8, 618-628 (2011).
25. Kuo, T. F. et al. Selective elimination of human pluripotent stem cells by a marine natural product derivative. Journal of the American Chemical Society 136, 9798-9801 (2014).
26. Tateno, H. et al. A medium hyperglycosylated podocalyxin enables noninvasive and quantitative detection of tumorigenic human pluripotent stem cells. Scientific reports 4, 4069 (2014).
27. Kim, T. H., Ko, E. B., Kim, S. J. & Choi, J. W. Nanoscale film fabrication of various peptides on neural stem cell chip. Journal of biomedical nanotechnology 9, 307-311 (2013).
28. El-Said, W. A., Kim, T. H., Chung, Y. H. & Choi, J. W. Fabrication of new single cell chip to monitor intracellular and extracellular redox state based on spectroelectrochemical method. Biomaterials 40, 80-87 (2015).
29. Rao, B. M. & Zandstra, P. W. Culture development for human embryonic stem cell propagation: molecular aspects and challenges. Current opinion in biotechnology 16, 568-576 (2005).
30. Ludwig, T. E. et al. Feeder-independent culture of human embryonic stem cells. Nature methods 3, 637-646 (2006).
31. Thomson, J. A. et al. Embryonic stem cell lines derived from human blastocysts. Science 282, 1145-1147 (1998).
32. Lee, T. H. et al. Functional recapitulation of smooth muscle cells via induced pluripotent stem cells from human aortic smooth muscle cells. Circ Res 106, 120-128 (2010).
33. Lee, M. O. et al. Inhibition of pluripotent stem cell-derived teratoma formation by small molecules. Proc Natl Acad Sci USA (2013).
34. Tang, C. et al. An antibody against SSEA-5 glycan on human pluripotent stem cells enables removal of teratoma-forming cells. Nature Biotechnology 29, 829-U886 (2011).
35. Kuroda, T. et al. Highly sensitive in vitro methods for detection of residual undifferentiated cells in retinal pigment epithelial cells derived from human iPS cells. PLoS One 7, e37342 (2012).
36. Schwartz, S. D. et al. Human embryonic stem cell-derived retinal pigment epithelium in patients with age-related macular degeneration and Stargardt's macular dystrophy: follow-up of two open-label phase ½ studies. The Lancet (2014).
37. Wang, L., Dai, W. & Lu, L. Osmotic stress-induced phosphorylation of H2AX by polo-like kinase 3 affects cell cycle progression in human corneal epithelial cells. J Biol Chem 289, 29827-29835 (2014).
38. Li, Z., Yang, J. & Huang, H. Oxidative stress induces H2AX phosphorylation in human spermatozoa. FEBS Lett 580, 6161-6168 (2006).
39. Cha, H. et al. Wip1 directly dephosphorylates gamma-H2AX and attenuates the DNA damage response. Cancer Res 70, 4112-4122 (2010).
40. Choi, H. S. et al. Development of a decoy immunization strategy to identify cell-surface molecules expressed on undifferentiated human embryonic stem cells. Cell Tissue Res 333, 197-206 (2008).
41. Hirata, N. et al. A chemical probe that labels human pluripotent stem cells. Cell reports 6, 1165-1174 (2014).
42. Lee, A. S. et al. Effects of cell number on teratoma formation by human embryonic stem cells. Cell Cycle 8, 2608-2612 (2009).
43. Nandakumar, V. et al. A Low-Cost Electrochemical Biosensor for Rapid Bacterial Detection. Ieee Sens J 11, 210-216 (2011).
44. Liu, J. Y. et al. Highly sensitive and selective detection of cancer cell with a label-free electrochemical cytosensor. Biosens Bioelectron 41, 436-441 (2013).
45. El-Said, W. A., Yea, C. H., Kim, H., Oh, B. K. & Choi, J. W. Cell-based chip for the detection of anticancer effect on HeLa cells using cyclic voltammetry. Biosens Bioelectron 24, 1259-1265 (2009)
46. Toma, H. E., Araki, K. & Dovidauskas, S. A cyclic voltammetry experiment illustrating redox potentials, equilibrium constants and substitution reactions in coordination chemistry. Journal of Chemical Education 77, 1351-1353 (2000)
47. Chen, J. et al. Classification of cell types using a microfluidic device for mechanical and electrical measurement on single cells. Lab on a chip 11, 3174-3181 (2011)

1. A method for detection of undifferentiated pluripotent stem cells, the method comprising:
(a) applying an electric pulse to stem cells; and
(b) measuring a cathodic peak potential (E_{pc}) of stem cells,
wherein, if an electrochemical signal of −0.155 V<E_{pc}<0.000 V is detected, it is determined that undifferentiated pluripotent stem cells are present.

2. The method of claim 1, wherein the E_{pc} satisfies −0.110 V<E_{pc}<−0.050 V.

3. The method of claim 1, wherein a cathodic peak current (i_{pc}) at the E_{pc} increases in proportion to the number of undifferentiated pluripotent stem cells.

4. The method of claim 1, wherein the pluripotent stem cells are embryonic stem cells, induced pluripotent stem cells, embryonic germ cells, embryonic tumor cells, or adult stem cells.

5. A method for quantitative analysis of undifferentiated pluripotent stem cells, the method comprising:
(a) applying an electric pulse to stem cells;
(b) measuring a signal of −0.155 V<E_{pc}<0.000 V as a cathodic peak potential (E_{pc}) of the stem cells; and
(c) quantifying undifferentiated pluripotent stem cells according to a cathodic peak current (i_{pc}) at the E_{pc}.

6. The method of claim 5, wherein the E_{pc} satisfies −0.110 V<E_{pc}<−0.050 V.

7. The method of claim 5, wherein the cathodic peak current (i_{pc}) at the E_{pc} increases in proportion to the number of undifferentiated pluripotent stem cells.

8. The method of claim 1, wherein the pluripotent stem cells are embryonic stem cells, induced pluripotent stem cells, embryonic germ cells, embryonic tumor cells, or adult stem cells.

9. A cell chip for detection of undifferentiated pluripotent stem cells, the cell chip comprising: (a) a substrate onto which stem cells are adsorbable; and (b) a chamber capable of accommodating stem cells, wherein, when an electric pulse is applied to the stem cells and then a cathodic peak potential (E_{pc}) of the stem cells is measured, if an electrochemical signal (i_{pc}) corresponding to E_{pc} of −0.155 V<E_{pc}<0.000 V is detected, it is determined that undifferentiated pluripotent stem cells are present,
wherein the cathodic peak current (ipc) at the E_{pc} increases in proportion to the number of undifferentiated pluripotent stem cells.

10. The cell chip of claim 9, wherein the E_{pc} satisfies −0.110 V<E_{pc}<−0.050 V.

11. The cell chip of claim 9, wherein the cell chip comprises a working electrode, a counter electrode, and a reference electrode.

12. The cell chip of claim 9, wherein the cathodic peak potential (E_{pc}) is measured in stem cells in the presence of mTeSR1 medium.
